(19) United States
(12) Patent Application Publication
(10) Pub. No.: US 2005/0280604 A1
(43) Pub. Date: Dec. 22, 2005

(54) Materials and methods of derivitzation of electrodes for improved electrical performance of OLED display devices

(76) Inventor: Gabriel J. Caballero, Longmont, CO (US)

Correspondence Address: Gabriel Caballero, 859 Quebec Avenue, Longmont, CO, 80501, US

(21) Appl. No.: 11/157,627

(22) Filed: Jun. 21, 2005

Related U.S. Application Data
(60) Provisional application No. 60/581,827, filed on Jun. 21, 2004.

(51) Int. Cl. G09G 3/00; H01M 4/60; H05B 33/12

(52) U.S. Cl. 345/30; 429/213; 429/212; 313/503; 257/88; 428/917

(57) ABSTRACT

A method of derivitization of electrode surfaces in small molecule or polymeric organic light emitting diodes (OLED) and display devices employing the same are presented whereby and assemblage of molecular wires are employed. The assemblage of molecular wires facilitates the transportation of electrical energy from an inorganic electrode, such as indium-tin-oxide or doped silica, to organic layers of compounds and composites/polymers, found in conventional OLED materials and construction. Thereby, devices made in accordance with the invention have dramatically improved work function characteristics including a dramatic increase in the external quantum efficiency. In addition, the molecular wire components further stabilize the mechanical properties of OLED materials at the wire OLED interface.

### CROSS-REFERENCE TO RELATED APPLICATIONS

This application claims the benefit of U.S. Provisional Application Ser. No. 60/581,827, filed on Jun. 21, 2004, the disclosure of which is incorporated herein by reference to the extent not inconsistent with the disclosure herein.

### BACKGROUND OF THE INVENTION

1. Technical Field

The invention relates to organic light emitting devices. More particularly, the present invention relates to organic light emitting devices utilizing molecular compatibility between inorganic electrode surfaces and OLED and PLED materials.

2. Description of Related Art

Organic light emitting devices (OEDs) have begun to attract great interest for a multiplicity of applied uses. For example, attempts have been made to incorporate organic light emitting devices in display devices. Organic light emitting devices can potentially offer a number of advantages over other types of display technologies. In particular, compared with certain types of display technologies, organic light emitting devices have the potential to offer lower manufacturing costs, reduced energy requirements, and improved visual characteristics.

However, existing organic light emitting devices often suffer from a number of problems. Existing organic light emitting devices are typically formed by depositing multiple organic layers on a substrate. The requirement of multiple organic layers can result in added weight and additional manufacturing costs. Also, the organic layers are sometimes formed from amorphous or randomly oriented polymeric materials. As a result of such random orientation, electrical conductivity of the organic layers can be inadequate, and charged species can travel relatively great distances in three dimensions along the randomly oriented polymeric materials before reaching a fluorescent or phosphorescent species that can emit light. At the same time, such random orientation can lead to the formation of “micro-wells” that can act as capacitors to further lower the electrical conductivity of the organic layers. To produce light having a desired brightness, a greater electric field density is sometimes applied to the organic layers. However, the electric field density can lead to thermal breakdown or instability of the organic layers. In conjunction with molecular incompatibility at the interface between inorganic electrode surfaces and organic small molecule and polymeric materials utilized in OLED and PLED devices world wide, the problems described are perpetuated.

For the reasons stated above, a need has arisen to develop the electrode modificationing molecules and organic light emitting devices described heretofore.

### SUMMARY OF THE INVENTION

One aspect of the invention relates to an electrode modificationing molecule. Therein one embodiment of the invention, the electrode modificationing molecule comprises an anchoring group and the electrode modification group having a first end and a second end. The first end of the electrode modification group is covalently bonded to the anchoring group. The anchoring group consists of an inorganic atom such as silicon for example, which covalently attaches to an oxide layer of an inorganic electrode surface utilized in state of the art OLED devices, one such example is Indium-tin-oxide. The electrode modification group allows transport of electrical energy wherein the transport of electrical energy is one- or two-dimensional. One dimensional transport of electrical energy occurs when electrical energy travels along the longitudinal axis of the electrode modificationing molecule. Two-dimensional transport of electrical energy occurs when electrical energy travels between portions of different electrode modificationing molecules, for example, directed movement of electrical energy of two different electrode modificationing molecules.

Travel of electrical energy between electrode modificationing molecules can occur when portions of two different electrode modificationing molecules, for example, electrode modification groups, are linked together. Two-dimensional transport of electrical energy allows electrical energy transfer to occur even if a defect is present in a layer of light emitting molecules. The electrode modificationing molecule also comprises a molecular compatibility group bonded to the second end of the electrode modification group. The molecular recognition group acts as a nucleation site for deposited small molecule materials utilized in state of the art small molecule OLED devices and in the same capacity with state of the art polymeric PLED devices. A molecular recognition group can be a ligand which facilitates molecular interaction and stability with applied small molecule OLED or polymeric PLED materials components. The molecular recognition site in the capacity of a ligand can coordinate an emissive metal ion, preferably a lanthanide metal, which would act as a dopant enhancing emission site in small molecule OLED devices.

In one embodiment, the electrode modification group is a conjugated group extending from the anchoring group, said conjugated group having a first end bonded to the anchoring group and said conjugated group having a second end. A light emissive group is bonded to the second end of the conjugated group. In one embodiment, the conjugated group has formula (A-B)ₘ-A, m being an integer in the range of 1 to 19, A being an arylene group, B being one of an alkenylene group, an alkynylene group, and an iminylene group. Other embodiments of conjugated groups and electrode modification groups are discussed below.

In another aspect, the invention relates to a pixel or a pixel element. A pixel is a separately electrically addressable pixel element. A pixel element comprises one or more electrode modificationing molecules that can be the same or different. In one embodiment, a pixel element comprises one or more of the same electrode modificationing molecules. In another embodiment, the pixel element comprises one or more different electrode modificationing molecules. In yet another aspect, the invention relates to an organic light emitting device. An organic light emitting device comprises one or more pixel elements comprising one or more electrode modificationing molecules, as described herein. In some instances, the one or more electrode modificationing molecules are substantially aligned with respect to a common direction, and each light emitting molecule of the pixel elements extends between the two conductive layers. In one embodiment, the organic light emitting device comprises one or more pixel elements. The pixel elements may be arranged in an array. At least one pixel element of the one or more pixel elements comprises one or more electrode modificationing molecules as described herein, wherein the anchoring group is configured to covalently bond the electrode modificationing molecule to an inorganic conductive layer and electrode modificationing group is covalently bonded to the molecular recognition group, which is configured to interact on a molecular level with both small molecule and polymeric materials utilized in state of the art OLED and PLED devices.

In a further aspect, the invention relates to a display device. In one embodiment, the display device comprises two conductive layers, for example, an anode layer and a cathode layer, and one or more pixel elements positioned between the two conductive layers. The pixel elements may be arranged in an array. At least one pixel element of the one or more pixel elements comprises one or more electrode modificationing molecules that comprises an anchoring group bonded to an inorganic conductive layer and a small molecule or polymeric OLED or PLED materials configured over the electrode modificationing elements followed by a second conductive layer.

In another embodiment, the display device comprises a first conductive layer, a second conductive layer, and one or more electrode modificationing molecules positioned between the first conductive layer and the second conductive layer. In one embodiment, the one or more transporting molecules are substantially aligned with respect to a common direction (meaning more molecules are aligned with respect to the common direction than molecules that are not aligned with respect to the common direction). In one embodiment, at least one electrode modificationing molecule of the one or more electrode modificationing molecules comprises an anchoring group bonded to the first inorganic conductive layer, a conjugated group extending from the anchoring group and having a first end bonded to the anchoring group and a second end, where a molecular recognition group is bonded to the second end of the conjugated group and the molecular recognition group interacts with a small molecule materials utilized in OLED device or a polymeric materials utilized PLED devices, which then interact with a second inorganic conductive layer.

### DETAILED DESCRIPTION

Various embodiments of the invention relate to electrode modificationing molecules and organic light emitting devices including such light emitting molecules. Organic light emitting devices in accordance with various embodiments of the invention can offer a number of advantages, such as, for example, improved transport of electrical energy, improved robustness and thermal stability, improved visual characteristics, reduced energy requirements, reduced weight and lower manufacturing costs.

Definitions:

The following definitions apply to some of the elements described with regard to some embodiments of the invention. These definitions may likewise be expanded upon herein.

As used herein, “array” means an arrangement of more than one electrode modificationing molecule or pixel element. Arrays can be ordered, where the relative spacing between electrode modificationing molecules or pixel elements and/or relative alignment of electrode modificationing molecules or pixel elements has been selected for a particular application. The array can have a regular order so that the relative spacing and/or relative alignment are substantially similar. Arrays can also have relative spacing and/or relative alignment of electrode modificationing molecules that is not regular. The electrode modificationing molecules in an array may be the same or different. Similarly, arrays can comprise more than one pixel element comprising the same electrode modificationing molecules, or can comprise more than one pixel element comprising different light emitting molecules.

As used herein, “electrode modificationing molecule” includes pre-light emitting molecules, those molecules which are capable of binding a luminescer and emitting light upon application of a suitable stimulus such as light or energy application. “Light emitting molecule” also includes molecules that are capable of emitting light upon application of a suitable stimulus such as light or energy application without binding a luminescer, for example, those light emitting molecules that include a luminescer. “Light emissive group” includes pre-light emissive groups, those groups which are capable of binding a luminescer and emitting light upon application of a suitable stimulus such as light or energy application. “Light emissive group” also includes groups that are capable of emitting light upon application of a suitable stimulus such as light or energy application, for example, those light emissive groups that include a luminescer.

As used herein, light emission means emission of any wavelength of light. Preferably, light emission means light that is detectable in the visible wavelength range. Preferably, light emission means light that is observable by the human eye (generally from 400 to 750 nm). Preferred visible wavelength ranges include those wavelengths that emit in the red color family (from 650 to 750 nm), the blue color family (from 435 to 500 nm) and the green color family (from 500 to 560 nm). Other regions of the spectrum and other colors are included in the term light emission. As described herein and known to one of ordinary skill in the art, the selection of the luminescer affects the wavelength of emission.

As used herein, “substantially” means more of the given structures have the listed property than do not have the listed property. For example, as used herein, “substantially aligned molecules” means at least about 50% of molecules in a group are aligned in a given direction.

As used herein, “substitution group” includes those groups commonly known in the art as “substituent” groups or groups that are added to a chemical structure.

As used herein, “configured to bond” means able to form a bond as defined herein.

As used herein, “anode layer” means a negatively charged group or surface. As used herein, “cathode layer” means a positively charged group or surface. As used herein, “conductive layer” means a layer having a conductive surface, for example an anode layer or cathode layer.

The term “set” refers to a collection of one or more elements. Elements of a set can also be referred to as members of the set. Elements of a set can be the same or different. In some instances, elements of a set can share one or more common characteristics.

The term “bond” and its grammatical variations refer to a coupling or joining of two or more chemical or physical elements. In some instances, a bond can refer to a coupling of two or more atoms based on an attractive interaction, such that these atoms can form a stable structure. Examples of bonds include chemical bonds such as chemisorptive bonds, covalent bonds, ionic bonds, van der Waals bonds, and hydrogen bonds. The term “intermolecular bond” refers to a chemical bond between two or more atoms that form different molecules, while the term “intramolecular bond” refers to a chemical bond between two or more atoms in a single molecule, such as, for example, a chemical bond between two groups of the single molecule. Typically, an intramolecular bond includes one or more covalent bonds, such as, for example, σ-bonds, π-bonds, and coordination bonds. The term “conjugated π-bond” refers to a π-bond that has a π-orbital overlapping (e.g., substantially overlapping) a π-orbital of an adjacent π-bond. Additional examples of bonds include various mechanical, physical, and electrical couplings.

The term “group” as applies to chemical species refers to a set of atoms that form a portion of a molecule. In some instances, a group can include two or more atoms that are bonded to one another to form a portion of a molecule. A group can be monovalent or polyvalent (e.g., bivalent) to allow bonding to one or more additional groups of a molecule. For example, a monovalent group can be envisioned as a molecule with one of its hydrogen atoms removed to allow bonding to another group of a molecule. A group can be positively or negatively charged. For example, a positively charged group can be envisioned as a neutral group with one or more protons (i.e., H+) added, and a negatively charged group can be envisioned as a neutral group with one or more protons removed. Examples of groups include alkyl groups, alkylene groups, alkenyl groups, alkenylene groups, alkynyl groups, alkynylene groups, aryl groups, arylene groups, iminyl groups, iminylene groups, hydride groups, halo groups, hydroxy groups, alkoxy groups, carboxy groups, thio groups, alkylthio groups, disulfide groups, cyano groups, nitro groups, amino groups, alkylamino groups, dialkylamino groups, silyl groups, and siloxy groups.

The term “conjugated group” refers to a group that includes a set of conjugated π-bonds. Typically, a set of conjugated π-bonds can extend through at least a portion of a length of a conjugated group. In some instances, a set of conjugated π-bonds can substantially extend through a length of a conjugated group. In other instances, a set of conjugated π-bonds can include one or more non-conjugated portions, such as, for example, one or more portions lacking substantial overlapping of π-orbitals. Examples of groups that can be used to form a conjugated group include alkylene groups, alkenylene groups, alkynylene groups, arylene groups, and iminylene groups. A conjugated group can be formed from a single group that includes a set of conjugated π-bonds. Alternatively, a conjugated group can be formed from multiple groups that are bonded to one another to provide a set of conjugated π-bonds. A conjugated group can contain ring structures or linear structures, or a combination of both. A conjugated group can, for example, be formed from a combination of one or more arylene groups and one or more alkenylene groups, alkynylene groups or iminylene groups. A conjugated group can include one or more of the groups shown in Scheme B, for example. A conjugated group can contain multiple groups that can be the same or different.

For example, a conjugated group can be formed from n arylene groups, where n is an integer that can be, for example, in the range of 2 to 20. The n arylene groups can be bonded to one another to form a chain structure, and the n arylene groups can include a single type of arylene group or multiple types of arylene groups. In some instances, each arylene group can be independently selected from lower arylene groups, upper arylene groups, monocyclic arylene groups, polycyclic arylene groups, heteroarylene groups, substituted arylene groups, and unsubstituted arylene groups. Each successive pair of arylene groups of the chain structure can be bonded to one another via a group that can be independently selected from alkenylene groups, alkynylene groups, and iminylene groups. For example, the conjugated group can be formed from n alkenylene groups, and the n alkenylene groups can include a single type of alkenylene group or multiple types of alkenylene groups. In some instances, each alkenylene group can be bonded to two successive arylene groups of the chain structure and can be independently selected from lower alkenylene groups, upper alkenylene groups, cycloalkenylene groups, heteroalkenylene groups, substituted alkenylene groups, and unsubstituted alkenylene groups. As another example, the conjugated group can be formed from n alkynylene groups that can be the same or different, and each alkynylene group can be bonded to two successive arylene groups of the chain structure. As a further example, the conjugated group can be formed from n iminylene groups that can be the same or different, and each iminylene group can be bonded to two successive arylene groups of the chain structure.

The term “electron accepting group” refers to a group that has a tendency to attract an electron from another group of the same or a different molecule. The term “electron donating group” refers to a group that has a tendency to provide an electron to another group of the same or a different molecule. For example, an electron accepting group can have a tendency to attract an electron from an electron donating group that is bonded to the electron accepting group. It should be recognized that electron accepting and electron providing characteristics of a group are relative. In particular, a group that serves as an electron accepting group in one molecule can serve as an electron donating group in another molecule. Examples of electron accepting groups include positively charged groups and groups including atoms with relatively high electronegativities, such as, for example, halo groups, hydroxy groups, cyano groups, and nitro groups. Examples of electron donating groups include negatively charged groups and groups including atoms with relatively low electronegativities, such as, for example, alkyl groups.

The term “alkane” refers to a saturated hydrocarbon molecule. For certain applications, an alkane can include from 1 to 100 carbon atoms. The term “lower alkane” refers to an alkane that includes from 1 to 20 carbon atoms, such as, for example, from 1 to 10 carbon atoms, while the term “upper alkane” refers to an alkane that includes more than 20 carbon atoms, such as, for example, from 21 to 100 carbon atoms. The term “small alkane” refers to an alkane having from 1 to 6 carbon atoms. The term “branched alkane” refers to an alkane that includes one or more branches, while the term “unbranched alkane” refers to an alkane that is straight-chained. The term “cycloalkane” refers to an alkane that includes one or more ring structures. The term “heteroalkane” refers to an alkane that has one or more of its carbon atoms replaced by one or more heteroatoms, such as, for example, N, Si, S, O, and P. The term “substituted alkane” refers to an alkane that has one or more of its hydrogen atoms replaced by one or more substituent groups, such as, for example, halo groups, hydroxy groups, alkoxy groups, carboxy groups, thio groups, alkylthio groups, cyano groups, nitro groups, amino groups, alkylamino groups, dialkylamino groups, silyl groups, and siloxy groups, while the term “unsubstituted alkane” refers to an alkane that lacks such substituent groups. Combinations of the above terms can be used to refer to an alkane having a combination of characteristics. For example, the term “branched lower alkane” can be used to refer to an alkane that includes from 1 to 20 carbon atoms and one or more branches. Examples of alkanes include methane, ethane, propane, cyclopropane, butane, 2-methylpropane, cyclobutane, and charged, hetero, or substituted forms thereof.

The term “alkyl group” refers to a monovalent form of an alkane. For example, an alkyl group can be envisioned as an alkane with one of its hydrogen atoms removed to allow bonding to another group of a molecule. The term “lower alkyl group” refers to a monovalent form of a lower alkane, while the term “upper alkyl group” refers to a monovalent form of an upper alkane. The term “branched alkyl group” refers to a monovalent form of a branched alkane, while the term “unbranched alkyl group” refers to a monovalent form of an unbranched alkane. The term “small alkyl group” refers to a monovalent form of a small alkane. The term “cycloalkyl group” refers to a monovalent form of a cycloalkane, and the term “heteroalkyl group” refers to a monovalent form of a heteroalkane. The term “substituted alkyl group” refers to a monovalent form of a substituted alkane, while the term “unsubstituted alkyl group” refers to a monovalent form of an unsubstituted alkane. Examples of alkyl groups include methyl, ethyl, n-propyl, isopropyl, cyclopropyl, butyl, isobutyl, t-butyl, cyclobutyl, and charged, hetero, or substituted forms thereof.

The term “alkylene group” refers to a bivalent form of an alkane. For example, an alkylene group can be envisioned as an alkane with two of its hydrogen atoms removed to allow bonding to one or more additional groups of a molecule. The term “lower alkylene group” refers to a bivalent form of a lower alkane, while the term “upper alkylene group” refers to a bivalent form of an upper alkane. The term “small alkylene group” refers to a bivalent form of a small alkane. The term “branched alkylene group” refers to a bivalent form of a branched alkane, while the term “unbranched alkylene group” refers to a bivalent form of an unbranched alkane. The term “cycloalkylene group” refers to a bivalent form of a cycloalkane, and the term “heteroalkylene group” refers to a bivalent form of a heteroalkane. The term “substituted alkylene group” refers to a bivalent form of a substituted alkane, while the term “unsubstituted alkylene group” refers to a bivalent form of an unsubstituted alkane. Examples of alkylene groups include methylene, ethylene, propylene, 2-methylpropylene, and charged, hetero, or substituted forms thereof.

The term “alkene” refers to an unsaturated hydrocarbon molecule that includes one or more carbon-carbon double bonds. For certain applications, an alkene can include from 2 to 100 carbon atoms. The term “lower alkene” refers to an alkene that includes from 2 to 20 carbon atoms, such as, for example, from 2 to 10 carbon atoms, while the term “upper alkene” refers to an alkene that includes more than 20 carbon atoms, such as, for example, from 21 to 100 carbon atoms. The term “small alkene” refers to an alkene group that includes from 1 to 6 carbon atoms. The term “cycloalkene” refers to an alkene that includes one or more ring structures. The term “heteroalkene” refers to an alkene that has one or more of its carbon atoms replaced by one or more heteroatoms, such as, for example, N, Si, S, O, and P. The term “substituted alkene” refers to an alkene that has one or more of its hydrogen atoms replaced by one or more substituent groups, such as, for example, alkyl groups, halo groups, hydroxy groups, alkoxy groups, carboxy groups, thio groups, alkylthio groups, cyano groups, nitro groups, amino groups, alkylamino groups, dialkylamino groups, silyl groups, and siloxy groups, while the term “unsubstituted alkene” refers to an alkene that lacks such substituent groups. Combinations of the above terms can be used to refer to an alkene having a combination of characteristics. For example, the term “substituted lower alkene” can be used to refer to an alkene that includes from 1 to 20 carbon atoms and one or more substituent groups. Examples of alkenes include ethene, propene, cyclopropene, 1-butene, trans-2 butene, cis-2-butene, 1,3-butadiene, 2-methylpropene, cyclobutene, and charged, hetero, or substituted forms thereof.

The term “alkenyl group” refers to a monovalent form of an alkene. For example, an alkenyl group can be envisioned as an alkene with one of its hydrogen atoms removed to allow bonding to another group of a molecule. The term “lower alkenyl group” refers to a monovalent form of a lower alkene, while the term “upper alkenyl group” refers to a monovalent form of an upper alkene. The term “small alkenylgroup” refers to a monovalent form of a small alkene. The term “cycloalkenyl group” refers to a monovalent form of a cycloalkene, and the term “heteroalkenyl group” refers to a monovalent form of a heteroalkene. The term “substituted alkenyl group” refers to a monovalent form of a substituted alkene, while the term “unsubstituted alkenyl group” refers to a monovalent form of an unsubstituted alkene. Examples of alkenyl groups include ethenyl, propenyl, isopropenyl, cyclopropenyl, butenyl, isobutenyl, t-butenyl, cyclobutenyl, and charged, hetero, or substituted forms thereof.

The term “alkenylene group” refers to a bivalent form of an alkene. For example, an alkenylene group can be envisioned as an alkene with two of its hydrogen atoms removed to allow bonding to one or more additional groups of a molecule. The term “lower alkenylene group” refers to a bivalent form of a lower alkene, while the term “upper alkenylene group” refers to a bivalent form of an upper alkene. The term “small alkenylene group” refers to a bivalent form of a small alkenylene. The term “cycloalkenylene group” refers to a bivalent form of a cycloalkene, and the term “heteroalkenylene group” refers to a bivalent form of a heteroalkene. The term “substituted alkenylene group” refers to a bivalent form of a substituted alkene, while the term “unsubstituted alkenylene group” refers to a bivalent form of an unsubstituted alkene. Examples of alkenyl groups include ethenylene, propenylene, 2-methylpropenylene, and charged, hetero, or substituted forms thereof.

The term “alkyne” refers to an unsaturated hydrocarbon molecule that includes one or more carbon-carbon triple bonds. In some instances, an alkyne can also include one or more carbon-carbon double bonds. For certain applications, an alkyne can include from 1 to 100 carbon atoms. The term “lower alkyne” refers to an alkyne that includes from 2 to 20 carbon atoms, such as, for example, from 2 to 10 carbon atoms, while the term “upper alkyne” refers to an alkyne that includes more than 20 carbon atoms, such as, for example, from 21 to 100 carbon atoms. The term “small alkyne” refers to an alkyne group that includes from 1 to 6 carbon atoms. The term “cycloalkyne” refers to an alkyne that includes one or more ring structures. The term “heteroalkyne” refers to an alkyne that has one or more of its carbon atoms replaced by one or more heteroatoms, such as, for example, N, Si, S, O, and P. The term “substituted alkyne” refers to an alkyne that has one or more of its hydrogen atoms replaced by one or more substituent groups, such as, for example, alkyl groups, alkenyl groups, halo groups, hydroxy groups, alkoxy groups, carboxy groups, thio groups, alkylthio groups, cyano groups, nitro groups, amino groups, alkylamino groups, dialkylamino groups, silyl groups, and siloxy groups, while the term “unsubstituted alkyne” refers to an alkyne that lacks such substituent groups. Combinations of the above terms can be used to refer to an alkyne having a combination of characteristics. For example, the term “substituted lower alkyne” can be used to refer to an alkyne that includes from 1 to 20 carbon atoms and one or more substituent groups. Examples of alkynes include ethyne (i.e., acetylene), propyne, 1-butyne, 1-buten-3-yne, 1-pentyne, 2-pentyne, 3-penten-1-yne, 1-penten-4-yne, 3-methyl-1-butyne, and charged, hetero, or substituted forms thereof.

The term “alkynyl group” refers to a monovalent form of an alkyne. For example, an alkynyl group can be envisioned as an alkyne with one of its hydrogen atoms removed to allow bonding to another group of a molecule. The term “lower alkynyl group” refers to a monovalent form of a lower alkyne, while the term “upper alkynyl group” refers to a monovalent form of an upper alkyne. The term “small alkynyl group” refers to a monovalent form of a small alkyne. The term “cycloalkynyl group” refers to a monovalent form of a cycloalkyne, and the term “heteroalkynyl group” refers to a monovalent form of a heteroalkyne. The term “substituted alkynyl group” refers to a monovalent form of a substituted alkyne, while the term “unsubstituted alkynyl group” refers to a monovalent form of an unsubstituted alkyne. Examples of alkynyl groups include ethynyl, propynyl, isopropynyl, butynyl, isobutynyl, t-butynyl, and charged, hetero, or substituted forms thereof.

The term “alkynylene group” refers to a bivalent form of an alkyne. For example, an alkynylene group can be envisioned as an alkyne with two of its hydrogen atoms removed to allow bonding to one or more additional groups of a molecule. The term “lower alkynylene group” refers to a bivalent form of a lower alkyne, while the term “upper alkynylene group” refers to a bivalent form of an upper alkyne. The term “small alkynylene group” refers to a bivalent form of a small alkyne. The term “cycloalkynylene group” refers to a bivalent form of a cycloalkyne, and the term “heteroalkynylene group” refers to a bivalent form of a heteroalkyne. The term “substituted alkynylene group” refers to a bivalent form of a substituted alkyne, while the term “unsubstituted alkynylene group” refers to a bivalent form of an unsubstituted alkyne. Examples of alkynylene groups include ethynylene, propynylene, 1-butynylene, 1-buten-3-ynylene, and charged, hetero, or substituted forms thereof.

The term “arene” refers to an aromatic hydrocarbon molecule. For certain applications, an arene can include from 5 to 100 carbon atoms. The term “lower arene” refers to an arene that includes from 5 to 20 carbon atoms, such as, for example, from 5 to 14 carbon atoms, while the term “upper arene” refers to an arene that includes more than 20 carbon atoms, such as, for example, from 21 to 100 carbon atoms. The term “small arene” refers to an arene group that includes from 5-7 carbon atoms. The term “monocyclic arene” refers to an arene that includes a single aromatic ring structure, while the term “polycyclic arene” refers to an arene that includes more than one aromatic ring structure, such as, for example, two or more aromatic ring structures that are bonded via a carbon-carbon single bond or that are fused together. The term “heteroarene” refers to an arene that has one or more of its carbon atoms replaced by one or more heteroatoms, such as, for example, N, Si, S, O, and P. The term “substituted arene” refers to an arene that has one or more of its hydrogen atoms replaced by one or more substituent groups, such as, for example, alkyl groups, alkenyl groups, alkynyl groups, iminyl groups, halo groups, hydroxy groups, alkoxy groups, carboxy groups, thio groups, alkylthio groups, cyano groups, nitro groups, amino groups, alkylamino groups, dialkylamino groups, silyl groups, and siloxy groups, while the term “unsubstituted arene” refers to an arene that lacks such substituent groups. Combinations of the above terms can be used to refer to an arene having a combination of characteristics. For example, the term “monocyclic lower alkene” can be used to refer to an arene that includes from 5 to 20 carbon atoms and a single aromatic ring structure. Examples of arenes include benzene, biphenyl, naphthalene, pyridine, pyridazine, pyrimidine, pyrazine, quinoline, isoquinoline, and charged, hetero, or substituted forms thereof.

The term “aryl group” refers to a monovalent form of an arene. For example, an aryl group can be envisioned as an arene with one of its hydrogen atoms removed to allow bonding to another group of a molecule. The term “lower aryl group” refers to a monovalent form of a lower arene, while the term “upper aryl group” refers to a monovalent form of an upper arene. The term “small aryl group” refers to a monovalent form of a small arene. The term “monocyclic aryl group” refers to a monovalent form of a monocyclic arene, while the term “polycyclic aryl group” refers to a monovalent form of a polycyclic arene. The term “heteroaryl group” refers to a monovalent form of a heteroarene. The term “substituted aryl group” refers to a monovalent form of a substituted arene, while the term “unsubstituted arene group” refers to a monovalent form of an unsubstituted arene. Examples of aryl groups include phenyl, biphenylyl, naphthyl, pyridinyl, pyridazinyl, pyrimidinyl, pyrazinyl, quinolyl, isoquinolyl, and charged, hetero, or substituted forms thereof.

The term “arylene group” refers to a bivalent form of an arene. For example, an arylene group can be envisioned as an arene with two of its hydrogen atoms removed to allow bonding to one or more additional groups of a molecule. The term “lower arylene group” refers to a bivalent form of a lower arene, while the term “upper arylene group” refers to a bivalent form of an upper arene. The term “small arylene group” refers to a bivalent form of a small arene. The term “monocyclic arylene group” refers to a bivalent form of a monocyclic arene, while theterm “polycyclic arylene group” refers to a bivalent form of a polycyclic arene. The term “heteroarylene group” refers to a bivalent form of a heteroarene. The term “substituted arylene group” refers to a bivalent form of a substituted arene, while the term “unsubstituted arylene group” refers to a bivalent form of an unsubstituted arene. Examples of arylene groups include phenylene, biphenylylene, naphthylene, pyridinylene, pyridazinylene, pyrimidinylene, pyrazinylene, quinolylene, isoquinolylene, and charged, hetero, or substituted forms thereof.

The term “imine” refers to a molecule that includes one or more carbon-nitrogen double bonds. For certain applications, an imine can include from 1 to 100 carbon atoms. The term “lower imine” refers to an imine that includes from 1 to 20 carbon atoms, such as, for example, from 1 to 10 carbon atoms, while the term “upper imine” refers to an imine that includes more than 20 carbon atoms, such as, for example, from 21 to 100 carbon atoms. The term “small imine” refers to an imine that has from 1 to 6 carbon atoms. The term “cycloimine” refers to an imine that includes one or more ring structures. The term “heteroimine” refers to an imine that has one or more of its carbon atoms replaced by one or more heteroatoms, such as, for example, N, Si, S, O, and P. The term “substituted imine” refers to an imine that has one or more of its hydrogen atoms replaced by one or more substituent groups, such as, for example, alkyl groups, alkenyl groups, alkynyl groups, halo groups, hydroxy groups, alkoxy groups, carboxy groups, thio groups, alkylthio groups, cyano groups, nitro groups, amino groups, alkylamino groups, dialkylamino groups, silyl groups, and siloxy groups, while the term “unsubstituted imine” refers to an imine that lacks such substituent groups. Combinations of the above terms can be used to refer to an imine having a combination of characteristics. For example, the term “substituted lower imine” can be used to refer to an imine that includes from 1 to 20 carbon atoms and one or more substituent groups. Examples of imines include R^{a}CH═NR^{b}, where R^{a} and R^{b} are independently selected from hydride groups, alkyl groups, alkenyl groups, and alkynyl groups.

The term “iminyl group” refers to a monovalent form of an imine. For example, an iminyl group can be envisioned as an imine with one of its hydrogen atoms removed to allow bonding to another group of a molecule. The term “lower iminyl group” refers to a monovalent form of a lower imine, while the term “upper iminyl group” refers to a monovalent form of an upper imine. The term “small iminyl group” refers to a monovalent form of a small imine. The term “cycloiminyl group” refers to a monovalent form of a cycloimine, and the term “heteroiminyl group” refers to a monovalent form of a heteroimine. The term “substituted iminyl group” refers to a monovalent form of a substituted imine, while the term “unsubstituted iminyl group” refers to a monovalent form of an unsubstituted imine. Examples of iminyl groups include —R^{c}CH═NR^{d}, R^{e}CH═NR^{f}—, —CH═NR^{g}, and R^{h}CH═N—, where R^{d} and R^{f} are independently selected from alkylene groups, alkenylene groups, and alkynylene groups, and R^{d}, R^{e}, R^{g}, and R^{h} are independently selected from hydride groups, halo groups, alkyl groups, alkenyl groups, and alkynyl groups.

The term “iminylene group” refers to a bivalent form of an imine. For example, an iminylene group can be envisioned as an imine with two of its hydrogen atoms removed to allow bonding to one or more additional groups of a molecule. The term “lower iminylene group” refers to a bivalent form of a lower imine, while the term “upper iminylene group” refers to a bivalent form of an upper imine. The term “small iminylene group” refers to a bivalent form of a small imine. The term “cycloiminylene group” refers to a bivalent form of a cycloimine, and the term “heteroiminylene group” refers to a bivalent form of a heteroimine. The term “substituted iminylene group” refers to a bivalent form of a substituted imine, while the term “unsubstituted iminylene group” refers to a bivalent form of an unsubstituted imine. Examples of iminylene groups include —RⁱCH═NR^{j}—, —CH═NR^{k}—, —R¹CH═N—, and —CH═N—, where Rⁱ, R^{j}, R^{k}, and R^{l} are independently selected from alkylene groups, alkenylene groups, and alkynylene groups.

The term “hydride group” refers to —H, which may be negatively charged

The term “halo group” refers to —X, where X is a halogen atom. Examples of halo groups include fluoro, chloro, bromo, and iodo.

The term “hydroxy group” refers to —OH.

The term “alkoxy group” refers to —OR^{m}, where R^{m} is an alkyl group. Examples of alkoxy groups include methoxy, ethoxy, propoxy, isopropoxy, and charged, hetero, or substituted forms thereof.

The term “carboxy group” refers to —COOH.

The term “thio group” refers to —SH.

The term “alkylthio group” refers to a —SRⁿ, where Rⁿ is an alkyl group. Examples of alkylthio groups include methylthio, ethylthio, propylthio, isopropylthio, and charged, hetero, or substituted forms thereof.

The term “disulfide group” refers to —S—S—.

The term “cyano group” refers to —CN.

The term “nitro group” refers to —NO₂.

The term “amino group” refers to —NH₂.

The term “alkylamino group” refers to —NHR^{o}, where R^{o} is an alkyl group. Examples of alkylamino groups include methylamino, ethylamino, propylamino, isopropylamino, and charged, hetero, or substituted forms thereof.

The term “dialkylamino group” refers to —NR^{p}R^{q}, where R^{p} and R^{q} are independently selected from alkyl groups. Examples of dialkylamino groups include dimethylamino, methylethylamino, diethylamino, dipropylamino, and charged, hetero, or substituted forms thereof.

The term “silyl group” refers to —SiR^{r}R^{s}R^{t}, where R^{r}, R^{s}, and R^{t} are independently selected from a number of groups, such as, for example, hydride groups, halo groups, alkyl groups, alkenyl groups, and alkynyl groups. Examples of silyl groups include trimethylsilyl, dimethylethylsilyl, diethylmethylsilyl, triethylsilyl, and charged, hetero, or substituted forms thereof. The term “siloxy group” refers to —O—SiR^{u}R^{v}R^{w}, where R^{u}, R^{v}, and R^{w} are independently selected from a number of groups, such as, for example, hydride groups, halo groups, alkyl groups, alkenyl groups, and alkynyl groups. Examples of siloxy groups include trimethylsiloxy, dimethylethylsiloxy, diethylmethylsiloxy, triethylsiloxy, and charged, hetero, or substituted forms thereof.

The term “silane” refers to a chemical structure based on SiH₄, where one or more of the hydrogens may be replaced with any group that binds to the silicon atom, such as halogen, oxygen, alkyl groups, alkenyl groups, and alkynyl groups.

The term “luminescer” refers to one or more atoms configured to emit light in response to an energy excitation. In some instances, a luminescer can form a portion of a molecule. A luminescer can emit light in accordance with a number of mechanisms, such as, for example, chemiluminescence, electroluminescence, photoluminescence, and combinations thereof. For example, a luminescer can exhibit photoluminescence in accordance with an absorption-energy transfer-emission mechanism, fluorescence, or phosphorescence. In some instances, a luminescer can be selected based on a desired wavelength or range of wavelengths of light emitted by the luminescer. Examples of luminescers include organic fluorescers, semiconductor nanocrystals, chromophores, including metal-containing chromophores and nonmetal-containing chromophores. Thus, for certain applications, a luminescer can include a metal atom, such as, for example, a transition metal atom or a lanthanide metal atom. Examples of transition metals atoms include Cd, Cu, Co, Pd, Zn, Fe, Ru, Rh, Os, Re, Pt, Sc, Ti, V, Cr, Mn, Ni, Mo, Tc, W, La, and Ir. Examples of lanthanide metal atoms include Sm, Eu, Gd, Dy, Th, Tm, Yb, and Lu. Typically, a metal atom that is part of a luminescer is positively charged and is provided in the form of a metal ion. As known in the art, the oxidation state of the metal ion depends on the species around it, and the metal ion can have a variety of charges, for example +3, +2, +1, etc.

The term “ligand” refers to one or more atoms configured to bond to a target. In some instances, a ligand can form a portion of a molecule. A ligand can be configured to bond to a luminescer to form a ligand-luminescer complex. A ligand can include a set of coordination atoms to allow bonding to a luminescer. Examples of coordination atoms that can form coordination bonds with a luminescer include N, C, Si, S, O, P, and halogens. In particular, halogens can act as coordination donors to the ligated metal. Halogens can displace water, but can result in a longer time of emission, as known in the art. In some instances, the number and type of coordination atoms can depend on a particular luminescer to be bonded. For certain applications, the number and type of coordination atoms can be selected based on a coordination number of a metal ion. For example, when a metal ion has a coordination number of 9, a ligand can include up to 9 coordination atoms to allow bonding to the metal ion. Ligands can be multidentate. A ligand can be monocyclic (i.e., include a single ring structure) or polycyclic (i.e., include more than one ring structure). In some instances, a ligand can encage a luminescer within a cavity or other bonding site formed by the ligand. Examples of ligands include crown ethers such as 12-crown-4,15-crown-5,18-crown-6, and 4,13-diaza-18-crown-6, polycyclic ligands such as 4,7,13,16,21-pentaoxa-1,10-diaza bicyclo [8,8,5] heneicosane, and monovalent or polyvalent forms thereof. Other examples of ligands include cryptand structures such as those described with Formulas II and III below. In one embodiment, a light emissive group includes one or more ligands and one or more luminescers.

The word “monolayer” and “layer” are used interchangeably herein to designate a layer of molecules or atoms is present on the surface, not to indicate that a perfect monolayer of molecules or atoms is formed, i.e., there is one molecule or atom present in every available position on the surface. There may be gaps or defects present in a layer of molecules or atoms present on the surface, as long as the gaps or defects do not prevent the desired function.

The term “conductive layer” refers to a structure formed from one or more electrically conductive materials. Examples of electrically conductive materials include metals, such as copper, silver, gold, platinum, palladium, and aluminum; metal oxides, such as platinum oxide, palladium oxide, aluminum oxide, magnesium oxide, titanium oxide, tin oxide, indium tin oxide, molybdenum oxide, tungsten oxide, and ruthenium oxide; and electrically conductive polymeric materials. For certain applications, an electrically conductive material can be deposited on or otherwise applied to a substrate to form a conductive layer. For example, an electrically conductive material can be deposited on a glass substrate or a silicon wafer or a plastic substrate to form a conductive layer. The substrate can be flexible. In other applications, the substrate is itself conductive. In some instances, a conductive layer can have a substantially uniform thickness and a substantially flat outer surface. In other instances, a conductive layer can have a variable thickness and a curved, stepped, or jagged outer surface. As used herein, “outer” means the side of the layer that is away from the substrate. A conductive layer can be configured as an anode layer or a cathode layer. For certain applications, a conductive layer can be substantially transparent or translucent. For example, a conductive layer can be formed from an electrically conductive material that is substantially transparent or translucent, such as, for example, magnesium oxide, indium tin oxide, or an electrically conductive polymeric material. As another example, a conductive layer can be formed with a thickness that allows light to be transmitted through the conductive layer.

The following examples are provided as a guide for a practitioner of ordinary skill in the art. The examples should not be construed as limiting the invention, as the examples merely provide specific methodology useful in understanding and practicing some embodiments of the invention.

Organic Light Emitting Devices

Synthesis of various parts of the structures disclosed herein have been discussed in the literature, e.g., Dhirani et al., J.A.C.S., 118,3319, (1996); Supramolecular Chemistry, Jean-Marie Lehr, Venlog Sgesellschaft, Weinhein Germany. Typical literature discussing the synthesis of various supramolecular cryptands include: Juan-Carlos Rodriguez-Ubis' et al., Synthesis of the Sodium Cryptates of Macrobicyclic Ligands Containing Bipyridine and Phenanthroline Groups, Helvetica Chemica Acta, Vol. 67 (1984) pp. 2264-2269; Beatrice Alpha et al., Synthesis and Characterisation of the Sodium and Lithium Cryptates of Macrobicyclic Ligands Incorporating Pyridine, Bipyridine, and Biisoquinoline Units, Helvetica Chemica Acta, Vol. 71 (1988), pp. 1042-1052; and Krzysztof E. Krakowiak et al., Synthesis of the Cyrptands. A Short Review, Israel Journal of Chemistry, Vol. 32, 1992, pp. 3-13, all of which are incorporated herein by reference. Self assembly procedures for cryptands are discussed in D. N. Reinhoud et al., Science, 295, 5564:2403 and Blasse, Chem. Phys. Lett. 246 (1988), 347-351, all of which are incorporated herein by reference.

Examples of Electrode Modificationing Molecules:

One embodiment of electrode modificationing molecules of the invention is illustrated by formula (I): 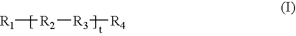
where R1 is an anchoring group; R2 is a electrode modification group; R3 is a pre-light emissive group capable of bonding to a luminescer; R4 is a molecular recognition group and t is an integer from 1 to 19;
R1 is preferably selected from the group consisting of: silanes, organic acids, amines, thiols, disulfide, amino, and alkylamino.

In one particular class of electrode modificationing molecules, pre-light emissive group R3 is given by formula (II): 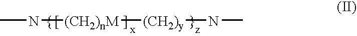
where M is independently selected from the group consisting of: O, NH, NR and S, where R is a small alkyl group and the N's may be charged; n and y are independently integers from 1 to 19; x is an integer from 1 to 19; and z is an integer from 1 to 3. In one preferred class of compounds, n and y are independently integers from 1 to 5. One particular example of compounds of formula (II) is given by the following structure:

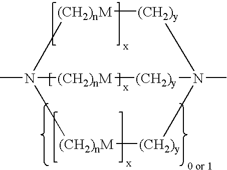

In the class of compound where R3 is given by formula (II), formula I is given by: 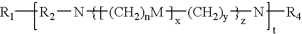
where the variables are as defined above. In a particular class of molecular recognition molecules, n and y are both 2; M is O; z is 2 or 3; t is 1 or 2; and x is 2.

In another class of molecular recognition molecules, pre-light emissive group R3 is given by formula (III): 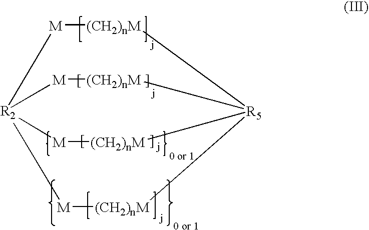
where R2 is a electrode modification group; R5 is either R2 or R4; the M's are independently selected from the group consisting of: O, NH, NR and S, where R is a small alkyl group and the N's may be charged; n is an integer from 1 to 3; j is an integer from 2-5. In formula III, the molecular recognition group is attached to the electrode modification group on one end (the R2 end) and either another electrode modification group or a charge transfer group at the other end (the R5 end). The R2 and R5 groups have 2 to 4 available bonds such as phenyl rings. This type of molecular recognition group is shown in FIG. 13 as element 245, for example.

One example of the molecular recognition group of Formula (III) is shown below that illustrates the bonding of the pre-light emissive group to R2 and R5: 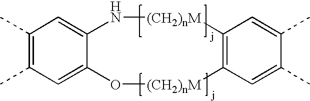
where the variables are as defined above, and the dashed lines indicate various groups may be added onto the R2 and R5 groups, as described further herein.

In the structures above, there may be optional alkyl linkers between the groups linking the molecular recognition group and the remainder of the structure.

Some classes of “pre” light emissive groups include the structures shown in Scheme A:

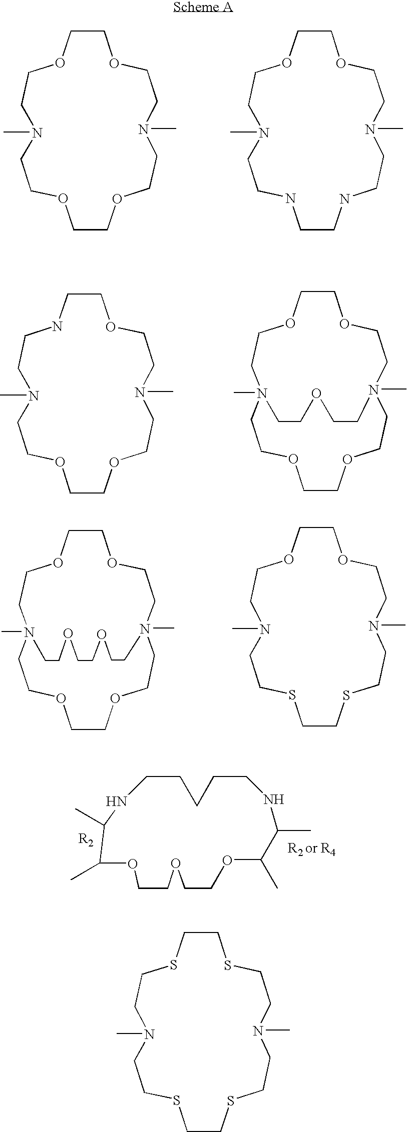

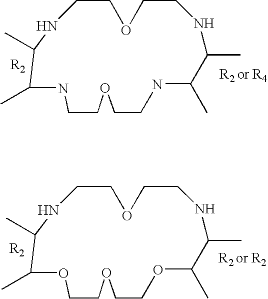

In one aspect of the use of ligand molecular recognition molecules, light emitting molecules containing one or more pre-light emissive groups are coordinated to one or more luminescers, electrical energy or light energy is applied to the light emitting molecules in conjunction with OLED/PLED, materials and the light emitting molecules emit the desired light.

Electrode modification group R2 can be any conjugated group. In particular classes of compounds of the invention, electrode modification group R2 is given by the structures in Scheme B. In Scheme B, w is an integer from 1 to 20 and w is preferably less than 10. In a class of electrode modification groups of the invention, w is an integer from 1 to 5. In another class of electrode modification groups of the invention, w is an integer from 5 to 10. If there is more than one w in a structure, the w's may be the same or different. In another class of electrode modification groups of the invention, w is an integer from 1 to 10. In another class of electrode modification groups of the invention, w is an integer from 2 to 5. It is understood that any of the components of the electrode modification groups shown in Scheme B and given herein may be repeated and combined in any order, as long as the resulting structure has the functions of the electrode modification group described herein.

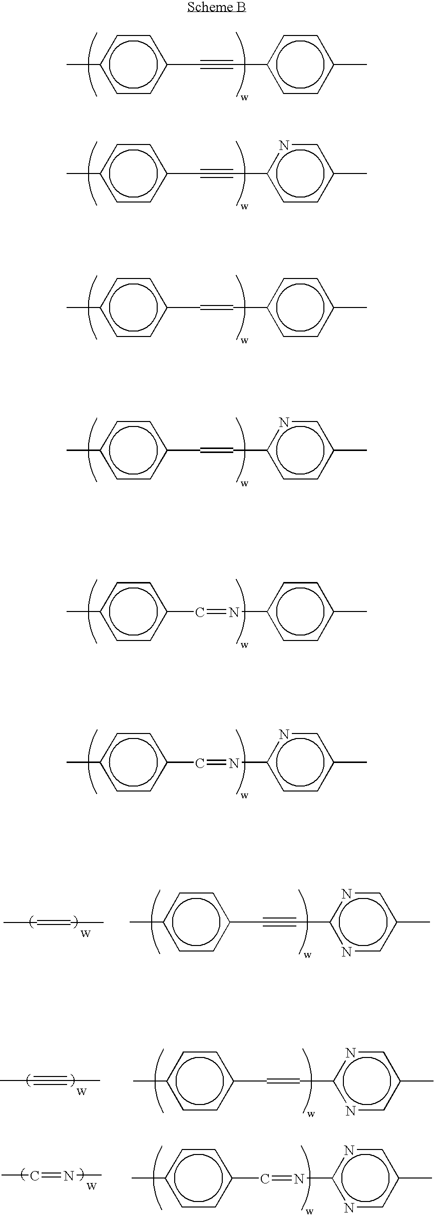

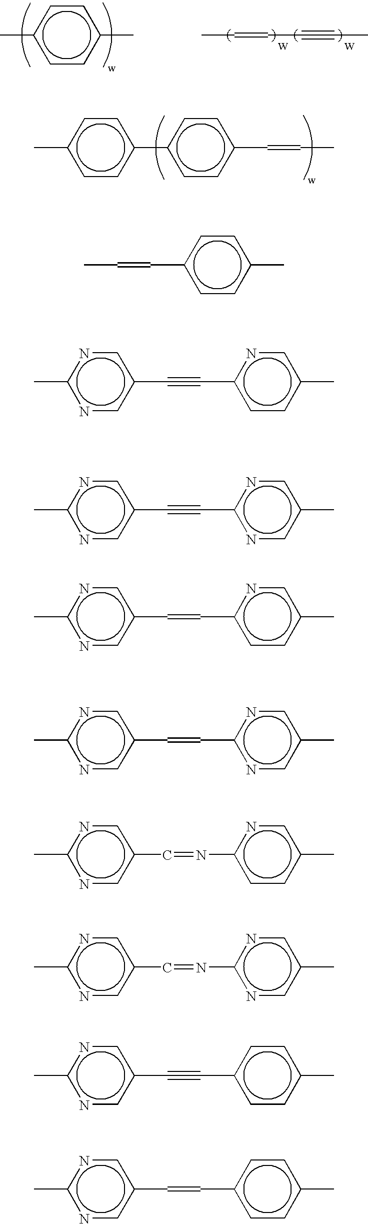

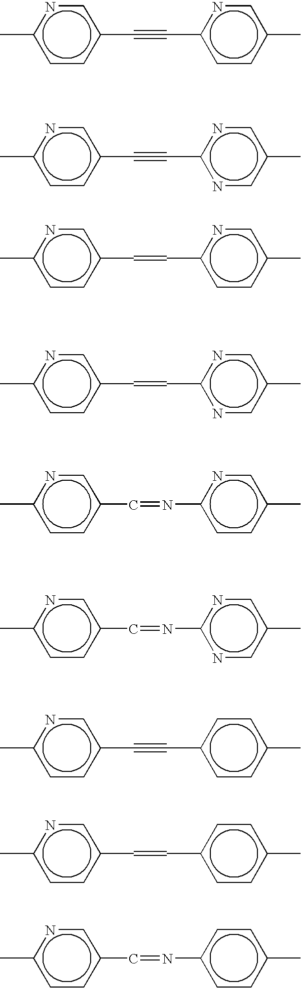

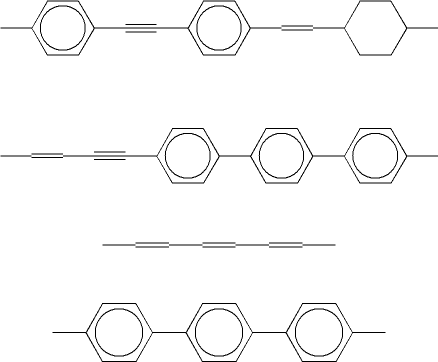

In particular classes of compounds of the invention, electrode modification group R3 is given by the formula: 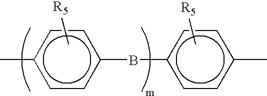
where m is an integer from 1 to 19 and B is an alkenylene, alkynylene or imidylene group. There are optionally one or two substituents R5 in the ring structures. R5 is independently an electron donating group; an electron withdrawing group; a halogen; —OH; or —OR, where R is a small alkyl group. One or two of the ring carbons of any ring may be replaced with a nitrogen.

In particular classes of compounds of the invention, R4 may be the same as described for the electrode modification group. In other particular classes of compounds of the invention, R4 is independently selected from the group consisting of: hydrogen, alkyl groups, alkylene groups, alkenyl groups, alkenylene groups, alkynyl groups, alkynylene groups, aryl groups, arylene groups, iminyl groups, iminylene groups, hydride groups, halo groups, hydroxy groups, alkoxy groups, carboxy groups, thio groups, alkylthio groups, disulfide groups, cyano groups, nitro groups, amino groups, alkylamino groups, dialkylamino groups, silyl groups, and siloxy groups. In one embodiment, R4 is an electron withdrawing group.

Synthesis of various components of electrode modificationing molecules is known to one of ordinary skill in the art using the methods and description provided herein.

One particular example of light emitting molecules of formula I is given in Scheme C, which also shows the formation of a layer of electrode modificationing molecules on a surface. In one class of electrode modificationing molecules where R1 is a silane, multiple charge molecules can be linked together as shown Scheme C. Although Scheme C shows all anchoring groups linked together, it is known in the art that some anchoring groups may not be linked to other anchoring groups.

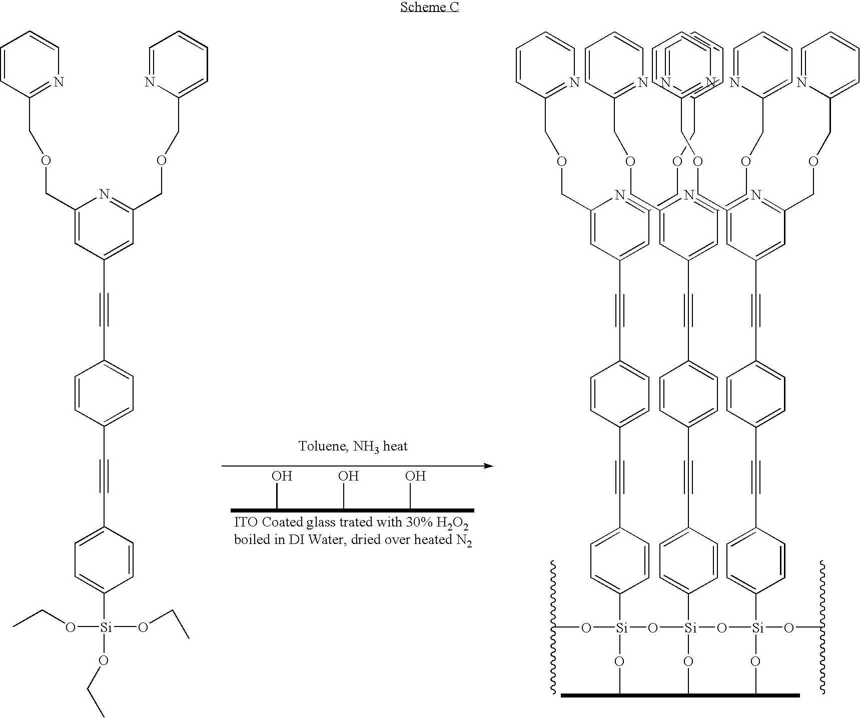

Included herein are pre-light emitting molecules, wherein the molecule is ready to receive a luminescer Examples of pre-light emitting molecules are given in Schemes C and D. In Scheme C, the pre-light emissive group is ready to receive a luminescer, such as Eu³⁺ is are shown with an engaged metal luminescer in Scheme D.

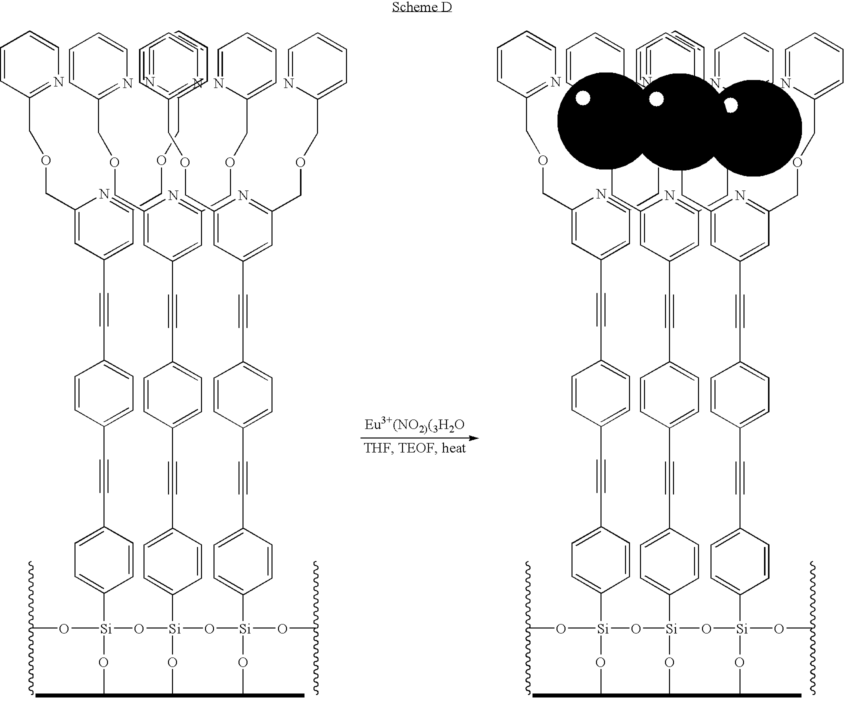

The electrode modificationing molecules of this invention can be prepared by various general synthetic procedures. The molecules can for example be synthesized completely and thereafter bonded to a surface, or portions of the molecules may be bonded to the surface and the remaining portions synthesized separated and then bonded to the portion that is bonded to the surface. In general, any of such molecular construction schemes can be employed to generate the surfaces having one or more electrode modificationing molecules bonded thereto. Further, the electrode modificationing molecules can be synthesized by complexing or otherwise bonding light emissive species, e.g., a luminescer, to pre-light emissive molecules, for example by complexing or bonding a metal atom luminescer to a ligand or coordination site within a pre-light emissive molecule. The luminescer can be complexed or bonded to the pre-light emitting molecule and the resulting electrode modificationing molecule can be bonded to a surface or the pre-light emitting molecule can be first bonded to a surface and thereafter the luminescer can be complexed or otherwise bonded to the surface-bound pre-light emitting molecule. Alternatively, the luminescer can be complexed or otherwise bonded to a ligand or coordination site in a portion of the pre-light emitting molecule which is thereafter reacted with another portion of the pre-light emitting molecule already attached to the surface. Electrode modification molecules can be treated to add substituent groups before or after they are bonded to a surface. Pre-light emitting molecules can be treated to add substituent groups before or after they are bonded to a surface. The electrode modification molecule is illustrated in scheme E as a single pixel element whereby the molecular recognition site has interaction with a single small molecule material utilized by state of the art OLED devices, depicted without further OLED materials required for optimum device performance. A second illustration in scheme F demonstrates the same configuration with the added dopant Europrium metal lumineser interacting with a single small molecule material utilized in state of the art OLED devices, also shown without further required OLED materials for optimum device performance. A similar example of a electrode modificationing molecule is depicted in scheme G, whereby a polymeric materials component utilized in PLED devices is shown interacting with the molecular recognition group of the electrode modification molecule anchored to an oxide on the surface of an Indium-tin-oxide electrode.

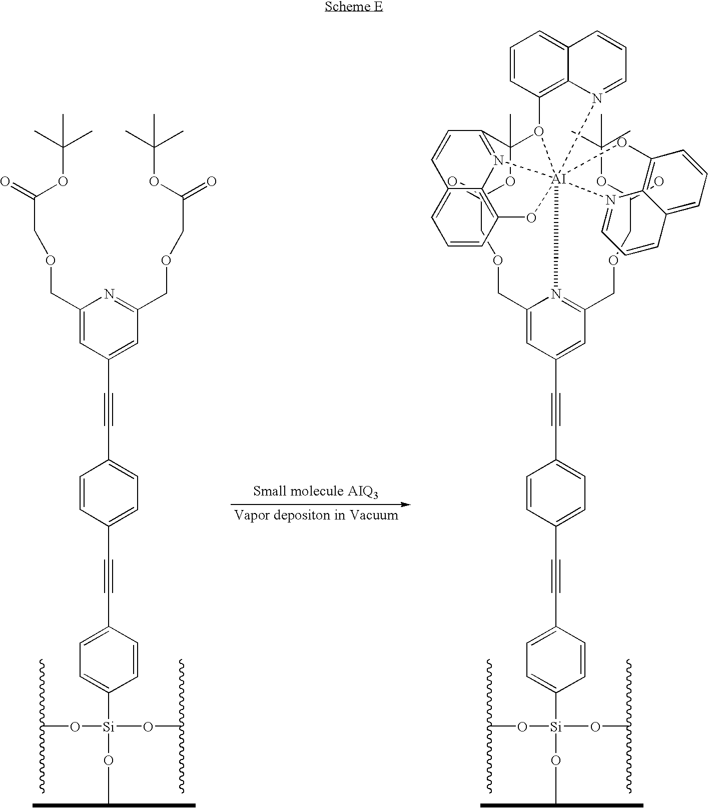

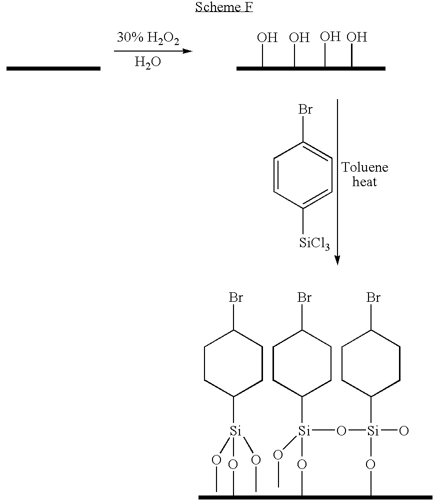

Schemes K and L illustrate various methods for synthesis of light emitting molecules of this invention. The methods illustrated show light-emitting molecules containing a macrocyclic ligand or multidentate ligand into which a luminescer metal atom can be introduced.

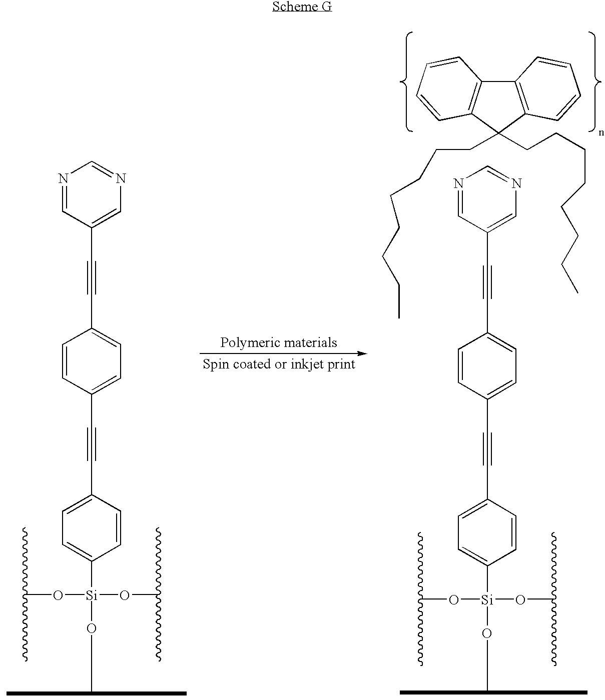

In an example, a substrate is coated with a desired thickness of ITO. The ITO-coated substrate is dipped into a solution of electrode modificationing molecules to form a self-assembled layer. The lateral density of coverage of electrode modificationing molecules is dependent on the length of the electrode modificationing group and molecular radial size of the molecular recognition site as one versed in the art would recognize. In addition, a solution of molecular spacers can be used to provide the desired level of coverage. Molecular spacers can include molecules that are electrically insulating, such as nonconjugated aliphatic molecules with or without halogenated substitutions which can provide functions such as providing separation between regions on the substrate. Molecular spacers can also include electrically conductive molecules, such as conjugated hydrocarbon chains. Electrically conductive molecules can have different end groups, for attaching to other groups, or for synthesis purposes. Some examples of different end groups include halogens such as —F, —Br, or —I; —≡—; or —δ—Si—(CH₃)₃. Alternatively, the electrode modification molecules can be formed step-wise on a substrate, however commercially impractical. One example of a first step of a step-wise formation of light emitting molecules is shown in Scheme F, where an Iridium-tin-oxide substrate is hydrated in hydrogen peroxide, followed by a reaction with a bromophenyltrichlorosilane to form a layer on the substrate. Further steps in the step-wise process are shown in Schemes C and D, where a silane surface is further reacted to form a surface having a layer of light emitting molecules. The peroxide is used to form an oxide layer on the surface of the ITO, which allows the water to form a hydroxide on the surface so the bromophenyltrichlorosilane or trimethoxysilane can react to form the stable covalent O—Si bond.

A sample of smooth indium tinoxide (ITO), coated substrate such as glass is taken and treated in a solution of 30% hydrogen peroxide (boiled 5 to 10 minutes and placed in sonic bath).

Substrate is then placed in solution of de-ionized water and boiled 60 seconds and placed in sonic bath for 35 to 90 seconds. Substrate removed and placed in a fresh solution of de-ionized water and boiled 60 seconds followed by sonication for 35 to 60 seconds. DI water wash repeated one more time followed by drying under a flow of heated and ultra-pure nitrogen. The substrate can be placed in a very clean vacuum oven for varied periods of time, temperature and pressure for drying. This procedure for cleaning and hydrolysis of an oxide surface may and have been used for other inorganic electrode surfaces such as doped silica-wafers.

A solution of the electrode derivitization molecules 10⁻³ M in purified toluene are prepared and placed in cleaned glass container. The hydrolyzed electrode substrate is placed in the solution and heated to boiling with or without stirring. A catalytic amount of triethylamine may be used to help shorten the time of self-assembled monolayer formation on the substrate surface. Formation may be monitored by in situ ellipsometery in cuvette as one versed in the art can construct. Reaction may continue from 20 minutes to 24 hours. Coated substrate is then removed and rinsed with purified toluene followed by suitable purified solvent such dichloromethane. Drying may ensue by dry heated and purified inert gas such as argon or nitrogen, or cleaned heated vacuum oven. The derrivitized substrate electrode may be doped by coordination of a lanthanide metal to the surface lone pairs off of the nitrogens as shown in RXN Scheme H below, then coated with OLED/PLED materials for device construction. Characterization and monitoring of lateral packing density may be accomplished by varied angle ESCA-XPS, Time of Flight Secondary Impact Mass Spectroscopy, ellipsometry and goniometry. The dried derrivitized electrode surface may used to construct OLED or PLED display device or solid state lighting devices by conventional device construction by one versed in the art.

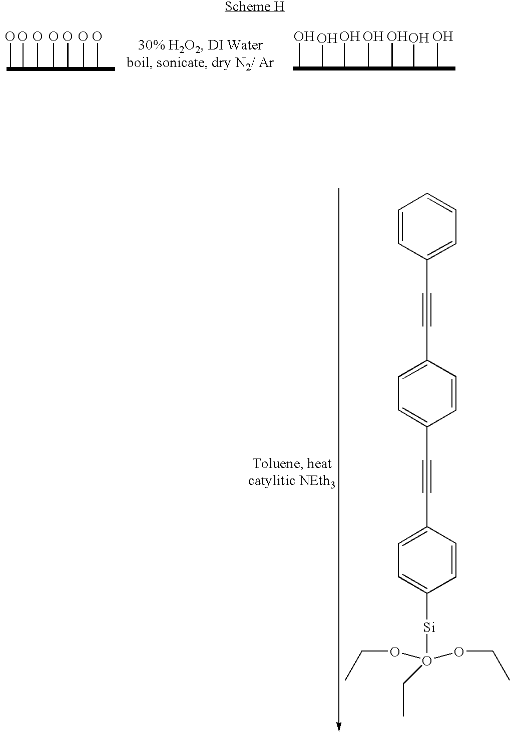

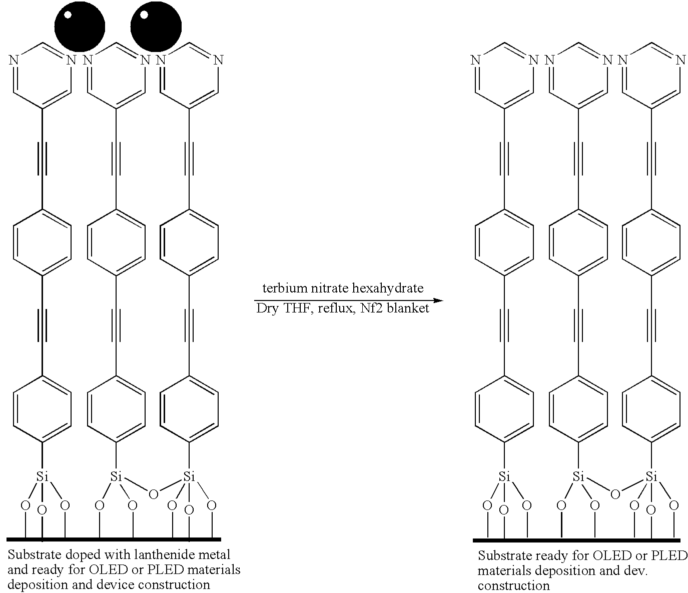

Furthermore, any device employing a plurality of electrode modificationing molecules in accordance with the present invention will have enhanced performance in stability, which lengthens the lifetime and improves the quantum efficiency of the device. This enhanced performance is realized whether the electrode modificationing molecules has an outer layer containing metal or containing essentially no metal, whether the device is a small molecule OLED device or a polymeric materials PLED device, and whether the device is employing an active matrix or a passive matrix addressing scheme. Also, the electrode modificationing molecules will enhance performance for flexible electrode substrates including polymeric electrode substrates.

Each of the patent applications, patents, publications, and other published documents mentioned or referred to in this specification are herein incorporated by reference in their entirety, to the same extent as if each individual patent application, patent, publication, and other published document was specifically and individually indicated to be incorporated by reference.

While the invention has been described with reference to the specific embodiments thereof, it should be understood by those skilled in the art that various changes may be made and equivalents may be substituted without departing from the true spirit and scope of the invention as defined by the appended claims. In addition, many modifications may be made to adapt a particular situation, material, composition of matter, method, process step or steps, to the objective, spirit and scope of the invention. All such modifications are intended to be within the scope of the claims appended hereto. In particular, while the methods disclosed herein have been described with reference to particular operations performed in a particular order, it will be understood that these operations may be combined, sub-divided, or re-ordered to form an equivalent method without departing from the teachings of the invention. Accordingly, unless specifically indicated herein, the order and grouping of the operations are not limitations of the invention.

1. Derivitization of electrode surfaces by methods of self-assembled mono-layers formation in the application of small molecule and polymeric electroluminescent organic light emitting diode devices, utilizing an electrode modification molecule, the electrode modification molecule comprising:
an anchoring group which forms a covalent bond to a conductive surface, wherein said anchoring group includes a nitrogen atom, an oxygen atom, a silicon atom or a sulfur atom;
an electrode modification group having a first end and a second end and a longitudinal axis wherein the first end of the electrode modification group is covalently bonded to the anchoring group and the electrode modification group is configured to provide the transport of electrical energy in substantially one dimension; and
a molecular recognition group covalently bonded to the second end of the electrode modification group.

2. The electrode modification molecule of claim 1, wherein the anchoring group includes an atom configured to form a covalent chemical bond with an anode layer.

3. The electrode modification molecule of claim 1, wherein the transport of electrical energy is substantially along the longitudinal axis of the electrode modification group.

4. The electrode modification molecule of claim 1, wherein the electrode modification group includes a conjugated group including a plurality of conjugated π-bonds.

5. The electrode modification molecule of claim 4, wherein the conjugated group includes at least one arylene group.

6. The electrode modification molecule of claim 5, wherein the conjugated group includes at least two arylene groups bonded to one another to form a chain structure.

7. The electrode modification molecule of claim 1, wherein the molecular recognition group is configured so as to interact on a molecular level with small molecule materials compounds utilized in small molecule organic light emitting diode devices.

8. The electrode modification molecule of claim 7, wherein the molecular recognition group further includes a ligand.

9. The electrode modification molecule of claim 8, wherein the ligand encapsulates a metal ion.

10. The electrode modification molecule of claim 9, wherein the encapsulated metal ion further interacts with small molecule organic light emitting diode materials providing an emissive dopant which further interacts with the small molecule materials utilized in organic light emitting diode devices.

11. The electrode modification molecule of claim 1, wherein the molecular recognition group is configured to interact on a molecular level with polymeric materials compounds utilized in polymer based organic light emitting diode devices.

12. The electrode modification molecule of claim 11, wherein the molecular recognition group further includes a ligand.

13. The electrode modification molecule of claim 12, wherein the ligand encapsulates a metal ion.

14. The electrode modification molecule of claim 13, wherein the encapsulated metal ion further interacts with polymeric materials compounds utilized in polymer based organic light emitting diode devices.

15. A pixel element comprising:
an electrode modification molecule including:
an anchoring group; and
a conjugated group extending from the anchoring group and having a first end covalently bonded to the anchoring group and an opposite, second end wherein the conjugated group has a formula (-A-B)ₘ-A, wherein m is an integer in the range of 1 to 19, A is an arylene group, B is one of an alkenylene group, an alkynylene group, and an iminylene group, and a molecular recognition group covalently bonded to the second end of the conjugated group.

16. The pixel element of claim 15, wherein the anchoring group is configured to bond a light emitting molecule to an anode or cathode layer.

17. The pixel element of claim 16, wherein the anchoring group includes an atom configured to form a chemical bond with the anode layer and the cathode layer, the atom being one of a nitrogen atom, an oxygen atom, a silicon atom, and a sulfur atom.

18. The pixel element of claim 15, wherein the conjugated group is configured to provide transport of electrical energy from the anchoring group to the molecular recognition group wherein the transport of electrical energy is substantially one-dimensional.

19. The pixel element of claim 18, wherein the conjugated group is configured to provide transport of electrical energy from the molecular recognition group to the anchor group wherein the transport of electrical energy is substantially one-dimensional.

20. The pixel element of claim 18, wherein A is one of phenylene, pyridinylene, and pyrimidinylene.

21. The pixel element of claim 15, wherein B is ethynylene.

22. An organic light emitting device comprising:
a plurality of pixel elements arranged in an array wherein at least one pixel element of said plurality of pixel elements includes an electrode modification molecule comprising an anchoring group covalently bonded to a first conductive layer;
an electrode modification group having a first end, a second end, and a longitudinal axis wherein the first end of the electrode modification group is covalently bonded to the anchoring group and the electrode modification group is configured to provide transport of electrical energy substantially along the longitudinal axis; and
a molecular recognition group covalently bonded to the second end of the electrode modification group and configured to interact on a molecular scale with small molecule and polymeric materials utilized in organic light emitting diode devices.

23. The organic light emitting device of claim 22, wherein the plurality of pixel elements are substantially aligned with respect to a common direction.

24. The organic light emitting device of claim 22, wherein the anchoring group includes one of a nitrogen atom, an oxygen atom, a silicon atom, and a sulfur atom.

25. The organic light emitting device of claim 22, wherein the longitudinal axis of the electrode modification group extends between the first end of the electrode modification group and the second end of the electrode modification group.

26. The organic light emitting device of claim 22, wherein the electrode modification group includes a plurality of conjugated π-bonds.

27. The organic light emitting device of claim 22, wherein the electrode modification group includes at least one of an alkenylene group, an alkynylene group, an arylene group, and an iminylene group.

28. The organic light emitting device of claim 22, wherein the electrode modification group includes a conjugated group having a formula (-A-B)ₘ-A, wherein m is an integer in the range of 1 to 19, A is an arylene group, and B is one of an alkenylene group, an alkynylene group, and an iminylene group.

29. The organic light emitting device of claim 22, wherein the molecular recognition group includes a ligand.

30. The organic light emitting device of claim 29, wherein the ligand further encapsulates a lanthanide metal ion.

31. A display device comprising:
an anode layer;
a cathode layer;
a plurality of pixel elements arranged in an array and positioned between the anode layer and the cathode layer wherein at least one pixel element of the plurality of pixel elements includes an electrode modification molecule that includes an anchoring group covalently bonded to the anode layer;
an electrode modificationing group having a first end and a second end wherein the first end is covalently bonded to the anchoring group;
a molecular recognition group covalently bonded to the second end of the electrode modification group; and
a small molecule materials formation utilized in organic light emitting diode devices that interacts with the molecular recognition group and cathode.

32. The display device of claim 31, wherein the anchoring group forms a covalent chemical bond with the anode layer.

33. The display device of claim 31, wherein the electrode modification group is configured to provide the transport of electrical energy substantially along a direction from the anode layer to the cathode layer or substantially along a direction from the cathode layer to the anode layer.

34. The display device of claim 33, wherein the direction defines an angle with respect to a direction orthogonal to the anode layer wherein the angle is in the range of about 0 to about 25 degrees.

35. The display device of claim 34, wherein the direction is substantially orthogonal to the surface of the anode layer.

36. The display device of claim 28, wherein the electrode modification group includes n arylene groups wherein n is an integer in the range of 2 to 20.

37. The display device of claim 33, wherein the n arylene groups are bonded to one another to form a chain structure.

35. The display device of claim 34, wherein the electrode modification group further includes n−1 alkylene groups, each alkylene group of the n−1 alkylene groups being bonded to two successive arylene groups of the chain structure.

36. The display device of claim 34, wherein the electrode modification group further includes n−1 alkenylene groups, each alkenylene group of the n−1 alkenylene groups being bonded to two successive arylene groups of the chain structure.

37. The display device of claim 34, wherein the electrode modification group further includes n−1 alkynylene groups, each alkynylene group of the n−1 alkynylene groups being bonded to two successive arylene groups of the chain structure.

38. The display device of claim 28, wherein the electrode modification group further includes n−1 iminylene groups, each iminylene group of the n−1 iminylene groups being bonded to two successive arylene groups of the chain structure.

39. The display device of claim 28, wherein the molecular recognition group further includes a ligand.

40. The display device of claim 39, wherein the ligand further encapsulates a metal ion.

41. A display device, comprising:
a first conductive layer;
a second conductive layer; and
a plurality of electrode modificationing molecules positioned between the first conductive layer and second conductive layer wherein the plurality of electrode modificationing molecules are substantially aligned with respect to a common direction, and at least one electrode modificationing molecule of the plurality of electrode modificationing molecules including:
an anchoring group covalently bonded to the first conductive layer;
a conjugated group extending from the anchoring group and having a first end covalently bonded to the anchoring group and an opposite second end; and
a plurality of small molecule or polymeric materials utilized in organic light emitting diode devices interacting with the molecular recognition group, followed by a second conductive layer.

42. The display device of claim 41, wherein the common direction defines an angle in the range of about 0 to about 25 degrees with respect to a direction orthogonal to the first conductive layer.

43. The display device of claim 42, wherein the angle is in the range of about 0 to about 10 degrees.

44. The display device of claim 41, wherein the anchoring group includes an atom configured to form a chemical bond with the first conductive layer, the atom being one of a nitrogen atom, an oxygen atom, a silicon atom, and a sulfur atom.

45. The display device of claim 41, wherein each electrode modificationing molecule of the plurality of electrode modificationing molecules includes an anchoring group wherein the anchoring groups are arranged in an array on a surface of the first conductive layer.

46. The display device of claim 41, wherein the conjugated group includes a plurality of conjugated π-bonds.

47. The display device of claim 41, wherein the conjugated group includes at least one arylene group.

48. The display device of claim 47, wherein the conjugated group includes n arylene groups, n being an integer in the range of 2 to 20.

49. The display device of claim 48, wherein the n arylene groups are bonded to one another to form a chain structure.

50. The display device of claim 49, wherein the conjugated group further includes at least one alkenylene group bonded to two successive arylene groups of the chain structure.

51. The display device of claim 50, wherein said conjugated group further includes n−1 alkenylene groups, each alkenylene group of said n−1 alkenylene groups being bonded to two successive arylene groups of said chain structure.

52. The display device of claim 49, wherein said conjugated group further includes at least one alkynylene group bonded to two successive arylene groups of said chain structure.

53. The display device of claim 52, wherein said conjugated group further includes n−1 alkynylene groups, each alkynylene group of said n−1 alkynylene groups being bonded to two successive anrylne groups of said chain structure.

54. The display device of claim 49, wherein said conjugated group further includes at least one iminylene group bonded to two successive arylene groups of said chain structure.

55. The display device of claim 54, wherein said conjugated group further includes n−1 iminylene groups, each iminylene group of said n−1 iminylene groups, each iminylene group being bonded to two successive arylene groups of said chain structure.

56. The display device of claim 41, wherein said molecular recognition group further includes a ligand, said ligand can interact with small molecule and polymeric OLED materials utilized in said OLED devices.

57. The display device of claim 56, wherein said ligand encapsulates a metal ion, which further interacts with small molecule and polymeric OLED materials.

58. The display device of claim 41, wherein the plurality of electrode modificationing molecules enhances device performance by improving stability.

59. The display device of claim 58, wherein the device is a small molecule OLED device having an outer layer above the electrode modificationing molecules comprised of metal or no metal and wherein the small molecule OLED device is addressed by active matrix or passive matrix addressing schemes.

60. The display device of claim 58, wherein the device is a polymeric materials PLED device having an outer layer above the electrode modificationing molecules comprised of metal or no metal and wherein the polymeric materials PLED device is addressed by active matrix or passive matrix addressing schemes.
